(19) United States
(12) Patent Application Publication
(10) Pub. No.: US 2015/0195403 A1
(43) Pub. Date: Jul. 9, 2015

(54) STOPPING ROBOCALLS

(71) Applicants: Mary Elizabeth Goulet, McLean, VA (US); Joseph R. Randazza, Boca Raton, FL (US)

(72) Inventors: Mary Elizabeth Goulet, McLean, VA (US); Joseph R. Randazza, Boca Raton, FL (US)

(21) Appl. No.: 14/663,513

(22) Filed: Mar. 20, 2015

Related U.S. Application Data
(63) Continuation-in-part of application No. 14/566,151, filed on Dec. 10, 2014.
Application No. 14/566,151 is a continuation of application No. 14/057,103, filed on Oct. 18, 2013, now Pat. No. 8,942,357.
(60) Provisional application No. 61/717,052, filed on Oct. 22, 2012.

(51) Int. Cl. H04M 3/436

(52) U.S. Cl. CPC H04M 3/436

(57) ABSTRACT

A robocall is prevented from reaching a telephone subscriber, by an automated calling screening system that tests for presence of a human caller on the line, and disconnects calls absent a predetermined response. Audio messages to stymy a robocaller but answerable by a human are used.

### FIELD OF THE INVENTION

The invention relates to preventing an unwanted robocall from disturbing a telephone subscriber who does not want to receive a robocall.

### BACKGROUND OF THE INVENTION

Robocalls (automated telephone calls conducted by a computerized system rather than by a human caller) generally are unwanted by the recipients.

Generally speaking, certain automated call screening systems have been disclosed in the

### PATENT LITERATURE

US Pat. Pub. 20040131164 by Gould, for “Method and apparatus for automated telephone call screening,”published Jul. 8, 2004;

U.S. Pat. No. 7,027,569 by Price, for “Telephone call screening system and method and caller registration system and method for use therewith,” issued Apr. 11, 2006;

U.S. Pat. No. 7,020,259 by Hussain, et al. (BellSouth), for “Privacy screening service for telecommunications,” issued Mar. 28, 2006;

US Pat. Pub. 20060188081 by Hooper et al., for “Systems and methods for call measurement,” published Aug. 24, 2006;

US Pat. Pub. 20060210032 by Grech et al. (Lucent Technologies, Inc.), for “Multilevel dynamic call screening,” published Sep. 21, 2006;

U.S. Pat. No. 7,162,019 by Mullis, et al. (BellSouth), for “System and method for privacy screening,” issued Jan. 9, 2007;

U.S. Pat. No. 7,212,620 by Mastro, for “System and method for providing an anti-telemarketing feature in a telephony network,” issued May 1, 2007;

US Pat. Pub. 20070127652 by Divine, et al., for “Method and system for processing calls,” published Jun. 7, 2007;

US Pat. Pub. 20070143422 by Cai, for “Phonebook use to filter unwanted telecommunications calls and messages,” published Jun. 21, 2007;

U.S. Pat. No. 7,295,660 by Higginbotham, et al. (AOL), for “Telemarketer screening,” issued Nov. 13, 2007;

U.S. Pat. No. 7,623,634 by Benco, et al. (Alcatel-Lucent USA Inc.), for “Network support for secure caller ID,” issued Nov. 24, 2009;

US Pat. Pub. 20110159856 by Walsh et al. (Oto Technologies, LLC), for “Apparatus and method of location based telecommunication authorization,” published Jun. 30, 2011;

U.S. Pat. No. 8,090,088 by Mullis, et al. (AT&T), for “System and method for privacy screening,” issued Jan. 3, 2012;

US Pat. Pub. 20120128144 by Chislett, et al. (Primus Telecommunications Canada Inc.), for “Screening system and method,” published May 24, 2012;

U.S. Pat. No. 8,363,803 by Gupta, for “Do Not Call list enforcement system and method,” issued Jan. 29, 2013;

US Pat. Pu. 2014015373 by Sharpe, for “Methods and systems for inbound call control,” published Apr. 17, 2014;

US Pat. Pub. 20140119527 by Cohen, for “Determining and denying call completion based on detection of robocall or unsolicited advertisement,” published May 1, 2014;

US Pat. Pub. 20140185786 by Korn, for “System, method and apparatus for call screening,” published Jul. 3, 2014;

US Pat. Pub. 20140192965 by Almeida, for “Method for blocking illegal prerecord messages (robocalls),” published Jul. 10, 2014;

US Pat. Pub. 20140219430 by Daniel, et al., for “Electronic system and method for screening incoming communications,” published Aug. 7, 2014;

U.S. Pat. No. 8,917,843 by Sharpe, for “Methods and systems for inbound call control,” issued Dec. 23, 2014;

US Pat. Pub. 20150078542 by Sharpe, for “Methods and systems for inbound call control,” published Mar. 19, 2015.

Also, the “Nomorobo” system developed by Aaron Foss is advertised. See nomorobo.com. The “Nomorobo” system is dependent upon being supported by the telephone carrier, and does not, for example, accept signups in connection with AT&T Wireless telephone numbers. The “Nomorobo” system appears to require that the telephone number to be enrolled must already be part of a multiple phone line plan in which “simultaneous ring” technology is in use, which does not characterize most telephones currently in use in the United States. The “Nomorobo” system permits an incoming robocall to ring once, and if the number of the incoming robocall is not already in the system's blacklist database, the incoming robocall will be permitted to ring further and will escape disconnect.

People continue to be bothered by robocalls. There remains an unmet need for automated systems that stop robocalls from disturbing a telephone subscriber who does not want to receive a robocall.

### SUMMARY OF THE INVENTION

The above-mentioned problems are addressed by a method, performed by an automated system comprising at least one computer, of preventing a robocall from reaching a telephone subscriber, comprising steps of: before an incoming telephone call is permitted to ring through to a telephone subscriber, pre-answering the incoming call, performed by the automated system; delivering an audio message (such as, e.g., an audio message that comprises a message along the lines of “this telephone subscriber does not receive robocalls; are you a human caller?”) which a human caller would be likely to be able to answer successfully but would be likely to be unanswerable by a non-human; disconnecting the incoming call unless the automated system receives a predetermined response pattern; and processing the incoming call for ring-through to the telephone subscriber if and only the predetermined response pattern has been received; such as, e.g., inventive methods further comprising a step of permitting a predefined time to pass, and if a predefined response (such as, e.g., a predefined response of “Y” or “YES”) has not been received back by the automated system, then the automated system disconnects the call; inventive methods wherein the steps are bypassed and not performed for telephone numbers that are indexed and/or saved under names by the telephone subscriber; inventive methods comprising culture-based questioning, wherein the audio message comprises a culture-based question; and other inventive methods.

The invention in another embodiment provides a method of preventing a robocall from reaching a telephone subscriber, by operating an automated calling screening system that tests for presence of a human caller on the line, and, before ringing through to the subscriber, disconnects calls absent a predetermined response indicating presence of a human caller.

In another embodiment, the invention provides an automated system comprising: a stored set of audio messages, wherein an audio message comprises a question that is designed to be answerable by a human but to defeat a robocalling system; a processor, processors, computer or computers that perforin steps of: pre-answering a call directed to a telephone subscriber; delivering, onto the line of the pre-answered call, an audio message from the stored set of audio messages; and screening the line of the call onto which the audio message has been delivered, for whether a predetermined response is detected, and, if the predetermined response is not detected, disconnecting the call before the call is permitted to ring-through to the telephone subscriber.

The invention in another embodiment provides a method, performed by an automated system comprising at least one computer, of preventing a robocall from reaching a telephone subscriber, comprising: testing a candidate audio message (such as, e.g., a message along the lines of “are you a human caller?”), performed by an automated test system comprising a Siri system and/or a robocalling system, for what output or response results from the candidate audio message; comparing an output or a response by the automated test system that resulted in the testing step against a set of predetermined response patterns for the candidate message, and (a) processing any candidate audio message for which the automated test system outputs or performs a response pattern that is among a set of predetermined response patterns that the automated system has associated with the candidate message, as a Failed candidate audio message and not adding the Failed candidate audio message to a database of audio messages used against actual incoming telephone calls; (b) processing any candidate audio message for which the automated test system outputs or performs a response pattern outside a set of predetermined response patterns that the automated system has associated with the candidate message, as Successful candidate audio message and adding the Successful candidate audio message to the database of audio messages used against actual incoming telephone calls in an audio-message-delivering step; before an incoming telephone call is permitted to ring through to a telephone subscriber, pre-answering the incoming call, performed by the automated system; delivering an audio message; disconnecting the incoming call unless the automated system receives a predetermined response pattern; and, processing the incoming call for ring-through to the telephone subscriber if and only if the predetermined response pattern has been received.

In another preferred embodiment the invention provides an automated system, comprising: a stored set of audio messages wherein an audio message comprises a sung instruction or question (such as, e.g., an audio message that comprises sung words forming an instruction substance and extraneous musical or vocal sounds; etc.); for each audio message, stored in association therewith, at least one predetermined response pattern that represents how a human is expected to respond; a processor, processors, computer or computers (that perform steps of: pre-answering a call directed to a telephone subscriber; delivering, onto the line of the pre-answered call, an audio message from the stored set of audio messages; screening the line of the call onto which the audio message has been delivered, for whether a predetermined response pattern associated with the audio message comprising the sung instruction or question is detected, and, if the predetermined response pattern for the question is not detected, disconnecting the call before the call is permitted to ring-through to the telephone subscriber).

In a preferred embodiment the invention provides a method of stopping robocalls from ringing-through, comprising: processing (performed by a computer, processor, or other machine of an automated system) incoming calls against a list of white-listed telephone numbers; for an incoming call from a telephone number that is not white-listed, before the incoming call that is not white-listed rings to a telephone subscriber, pre-answering the call, performed by a computer, processor or other machine of the automated system; for an incoming call from a telephone number that is white-listed, processing (performed by a computer, processor or other machine of the automated system) the incoming call for ring-through without pre-answering the incoming call; for an incoming call that is not white-listed and that has been pre-answered, performing a step of delivering (performed by a computer, processor or other machine of the automated system) an audio message; followed by, after the audio message has been delivered, determining (performed by a computer, processor, or other machine of the automated system) whether a predetermined response pattern has been received; and if no predetermined response pattern has been received, disconnecting the call; if and only if the predetermined response pattern has been received, processing the call for ring-through; such as, e.g., inventive methods wherein the automated system disconnects an incoming call that is a robocall before the robocall rings through to the telephone subscriber; inventive methods further comprising, after the disconnecting step has been performed, a step of sending, performed by the automated system, an email to the telephone subscriber in which the email content comprises at least one disconnected number (such as, e.g., inventive methods further comprising stock-piling, by the automated system, a set of disconnected numbers, and wherein the email to the telephone subscriber comprises a set of multiple disconnected numbers; inventive methods further comprising storing, performed by the automated system, third party content, and, prior to the email-sending, retrieving third party content and generating a coupon or message therefrom, followed by displaying the generated coupon or message into the to-be-sent email and sending the email in which is included the coupon or message and the at least one disconnected number; etc.); inventive methods further comprising forwarding, performed by the automated system, the incoming call that is arriving on a telephone line of the subscriber onto a different telephone line, wherein the different telephone line is outside an account of the telephone subscriber (such as, e.g., methods wherein the call pre-answering step is performed on the different telephone line); inventive methods wherein the call pre-answering step is performed on a telephone line which is outside an account of the telephone subscriber; and other inventive methods.

### BRIEF DESCRIPTION OF FIGURES

FIG. 1 depicts a flow chart of an embodiment of an inventive method in which each step shown is performed by a computer or machine in an automated system such as automated system 200.

FIG. 2 is a block diagram of an embodiment of an inventive automated system 200 in operation.

FIG. 3 depicts a flow chart of an embodiment of an inventive method in which each step shown is performed by a computer or machine in an automated system such as automated system 200.

FIG. 4 depicts a flow chart of another embodiment of an inventive method in which each step shown is performed by a computer or machine in an automated system such as automated system 200.

FIG. 5 depicts a flow chart of an aspect of an inventive method in which each step shown is performed by a computer or machine in an automated system such as automated system 200.

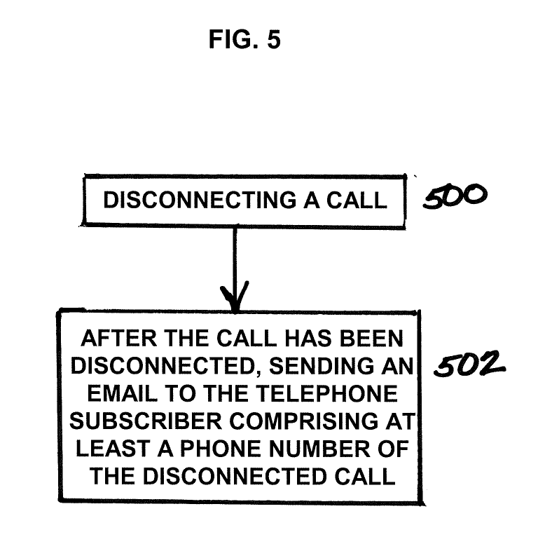

### DETAILED DESCRIPTION OF PREFERRED EMBODIMENT OF THE INVENTION

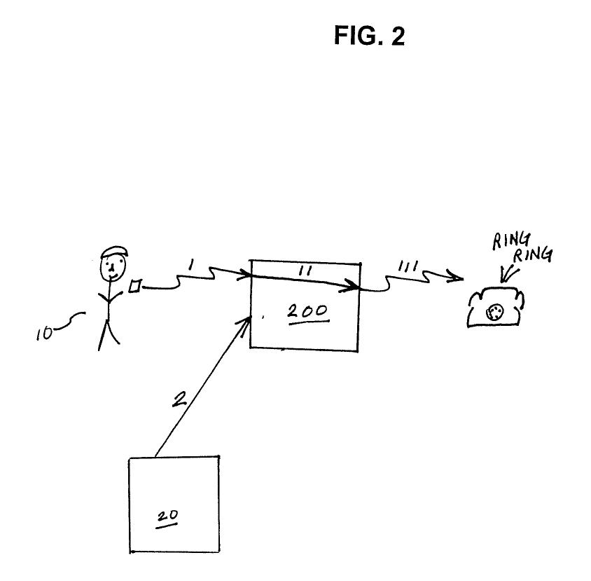

The inventive method of preventing a robocall (such as call 2 generated by computer system 20 in FIG. 2) from reaching a telephone subscriber (such as, e.g., a landline telephone subscriber; a cellular telephone subscriber) is performed by an automated system (such as automated system 200) comprising at least one computer, preferably an automated system that tests for a machine-readable predefined response (such as, e.g., a predefined response which is a predefined sequence of pushed telephone pad buttons).

An example of a machine-readable predefined response is a particular predefined sequence associated with certain pushed telephone keypad buttons, such as, e.g., a machine-readable signal that a “9” button has been pushed representing “Y” for “Yes” as opposed to no button having been pushed or a response associated with a “6” button meaning “N” for “No”; a machine-readable signal that an “8” button has been pushed representing “T” for “True” as opposed to no button having been pushed or a response associated with a “3” meaning “F” for “False”.

The automated system preferably performs a step, before an incoming telephone call is permitted to ring through to a telephone subscriber, of pre-answering 100 the incoming call.

For the pre-answered call, the automated system preferably performs a step of delivering 110 an audio message which a human caller would be likely to be able to answer successfully but would be likely to be unanswerable by a non-human.

An example of the audio message is an audio message that comprises a message along the lines of “this telephone subscriber does not receive robocalls; are you a human caller?” which a human caller would be expected to answer by pressing “Y” or the “Y-E-S” keys.

Another example of the audio message is an audio message that comprises a culture-based question that a human caller would be expected to be able to answer in a predefined manner that would be outside a machine's capability to produce.

Preferred examples of an audio message useable in practicing the invention are, e.g., an audio message that comprises a spoken name of a first individual who is the telephone subscriber or in a household of the telephone subscriber (such as, e.g., an audio message that comprises the spoken name of the first individual and an instruction of what to press (such as, e.g., an audio message that further comprises a spoken name of a second individual along with an instruction of what to press; an audio message that further comprises a spoken name of each additional individual in the household along with an instruction of what to press for each additional individual); etc.

Preferably the automated system screens for whether a predetermined response pattern has been received and performs a step of disconnecting 120 the incoming call unless the automated system has received the predetermined response pattern. Preferably the automated system permits a predefined time to pass, and if a response that has been predetermined as indicating a human caller's likely presence has not been received back by the automated system, then the automated system disconnects the call. Preferably the automated system checks for whether the predetermined response pattern has been received too quickly, such as receipt of a premature “Y” response which could have been sent by a preprogrammed robocall.

For example, human caller 10 in FIG. 2 generates call 1 which is pre-answered by automated system 200. The human call 10 listens to the audio messages delivered by the automated system 200 and gives the predetermined responses and the processed call 11 exits the as a rung-through call 111. By contrast, robocall 2 generated by robocalling system 20 is pre-answered by automated system 200, but cannot make it out of automated system 200 to be rung-through.

Preferably a question that is to be delivered by the automated system 200 is pre-tested against another automated system comprising a voice recognition system, for whether the question is machine-answerable, before being added to the stored questions that the automated system asks when pre-answering calls.

The automated system processes 130 the incoming call for ring-through to the telephone subscriber if and only the predetermined response pattern has been received. If the predetermined response pattern was not received, the incoming call would have been disconnected in the disconnecting step 120 and would not be susceptible of ring-through processing 130.

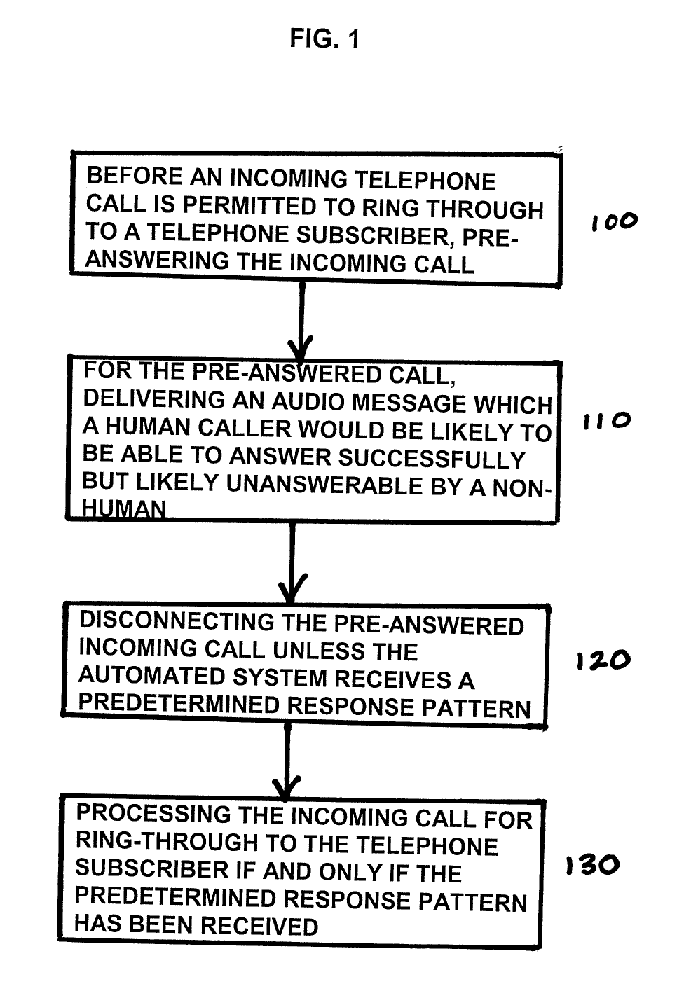

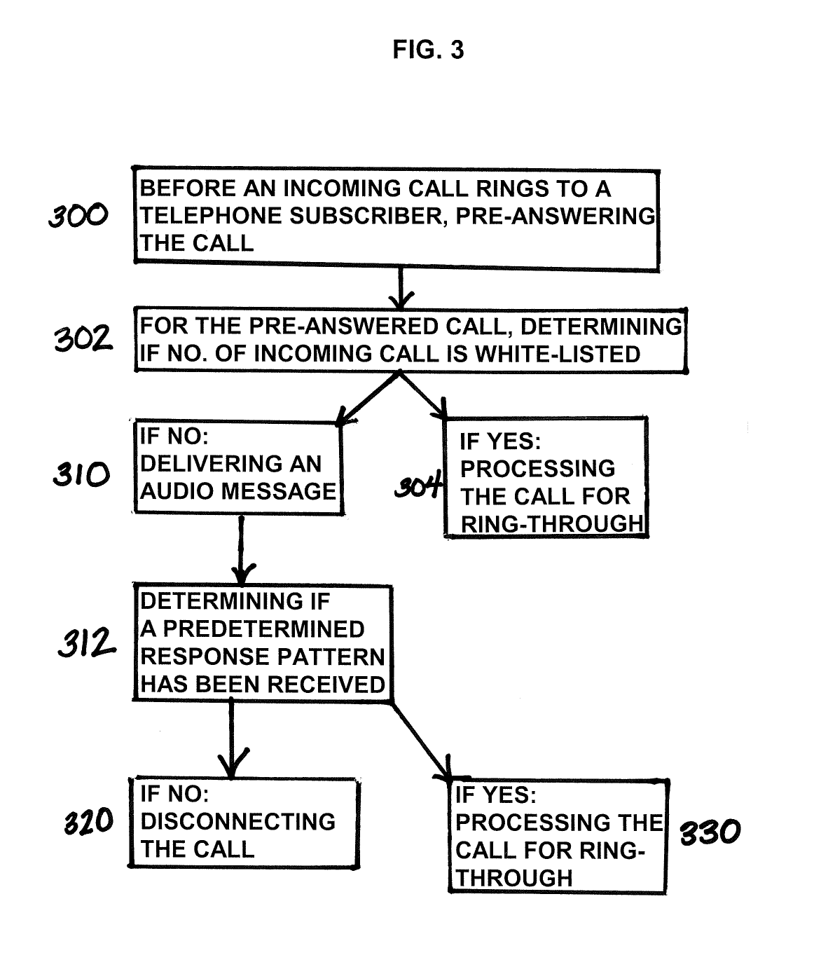

Preferably certain steps (such as, e.g., steps 100, 110, 120, 130 in FIG. 1; steps 310, 312, 320 in FIG. 3) are bypassed and not performed for certain incoming telephone numbers (such as, e.g., telephone numbers that are indexed and/or saved under names by the telephone subscriber).

### Example 1

An example of culture based questioning presentable in an inventive audio message is, e.g., “Press the “Y” or “N” key to indicate for the following activities that will be mentioned whether each is an activity that our current president is likely to be seen doing today: riding a motorcycle; jumping out of a helicopter; hitch-hiking; shaking hands; giving a speech . . . ”.

### Example 1A

The predefined responses stored by the automated system for the culture-based questions of Example 1 are:

riding a motorcycle—N (6)
jumping out of a helicopter—N (6)
hitch-hiking—N (6)
shaking hands—Y (9)
giving a speech—Y (9)

As the automated system delivers each question, if no response or a response other than the predefined response is detected by the automated system, the automated system disconnects the call and thus the disconnected call (such as, e.g., a disconnected robocall) does not ring through to the telephone subscriber to disturb her.

In an event that a human caller has been disconnected by the automated system, the human caller can re-dial.

### Example 1B

Further examples of questions useable in the invention are questions in a form of

During a job interview would you ______? (such as, e.g., shake hands?; spit?); Are ______ and ______ (such as, e.g., Mickey Mouse and Homer Simpson) in the same cartoon/show?;
Is ______ (such as, e.g., throwing eggs at the White House; declaring bankruptcy; avoiding illegal drugs) good for one's security clearance?;
Does McDonald's sell ______ (e.g., Big Macs; computers; construction equipment)?;
Have ______ (e.g., rotary telephones; hot air balloons; flying cities) been invented yet?

### Example 2

An automated system stores a large number (such as, e.g., over 100) questions considered not readily answerable in real-time by a machine, along with a predefined response for each question. For each phone call that is pre-answered by the automated system, the automated system selects a set of questions, which is a randomized set of questions that differs from call to call. The automated system performs a randomization step preparatory to constructing a set of questions to ask when pre-answering a call.

### Example 2A

The automated system is updated frequently (such as, e.g., weekly, daily, etc.) to add new questions and/or to remove questions.

### Example 2B

The questions are stored in the automated system in a form of prerecorded audio, recorded by a variety of different individuals speaking with different accents and/or dialects.

### Example 3

In this example, as an audio message used for robocall-stopping, a sung instruction is used, preferably a recording of a human having sung the sung instruction.

### Example 3A

In this example, an audio message includes sung words forming an instruction and also extraneous musical or vocal sounds (such as, e.g., at least one repetition of an immediately preceding word). For example, the sung instruction “enter the name of a color, but not the color blue” is modified with extraneous sounds to be “enter the name of a color, but not, not, not the color blue”.

### Example 4

A candidate audio message is tested against a robocalling system.

### Example 4A

A candidate audio message is tested against a Siri system (such as, e.g., the Siri computer system by Apple that receives and processes audio input).

### Example 5

Referring to FIG. 3, in this inventive example the following steps are performed by a computer or computers: before an incoming call rings to a telephone subscriber, pre-answering 300 the call; for the pre-answered call, determining 302 if the number of the incoming call is white-listed.

If the incoming call is determined in the determining step 302 to be white-listed, a step of processing 304 the call for ring-through is performed. If the incoming call is determining in the determining step 302 NOT to be white-listed, a step of delivering 310 an audio message is performed, after which is performed a step of determining 312 if a predetermined response pattern has been received.

If the result of the determining step 312 is that NO, the predetermined response pattern has NOT been received, then a step of disconnecting 320 the call is performed. If the result If the result of the determining step 312 is that NO, the predetermined response pattern has NOT been received, then a step of processing 330 the call for ring-through is performed.

Each of the steps of pre-answering 300, determining 302 whether white-listed, processing 304, delivering 310 an audio message, determining 312 whether a predetermined response pattern has been received; disconnecting 320 and processing 330 is performed by an automated system comprising at least one computer.

### Example 5A

In this Example, pre-answering 300 the incoming call comprises the incoming call being forwarded from the subscriber line onto a different telephone line, wherein the forwarding is performed by the automated system BEFORE the incoming call rings, and processing 304, 330 the call for ring-through comprises forwarding the incoming call from the different telephone line back onto the subscriber line.

### Example 5B

In this example, a list of white-listed numbers useable in the determining step 302 or other steps in which a white-list is used, comprises (1) a set of telephone numbers on which incoming calls that are forwarded are arriving and are being pre-answered by the automated system, and, optionally, (2) a set of telephone numbers received as input from the telephone subscriber.

### Example 6

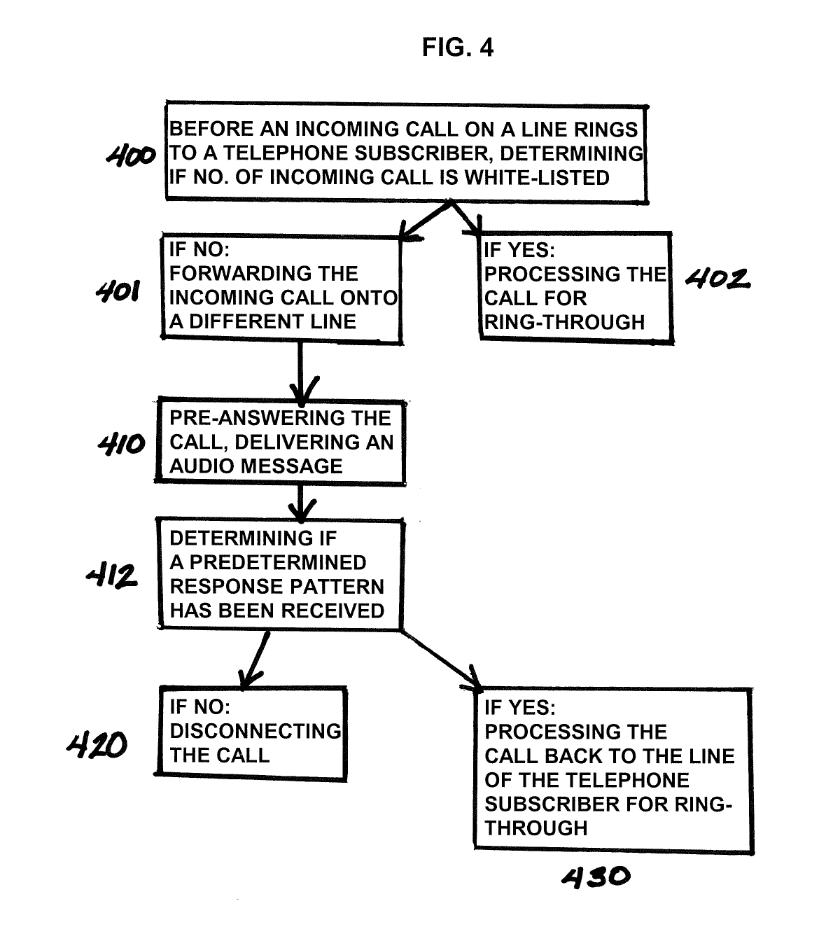

Referring to FIG. 4, in this inventive example the following steps are performed by a computer or computers: before an incoming call on a line rings to a telephone subscriber, determining 400 if the number of the incoming call is white-listed (such as, e.g., white-listed numbers of family, friends, colleagues), and if YES, processing 402 the call for ring-through, but if NO, forwarding 401 the incoming call onto a different line.

After the forwarding 401 of the call onto the different line, the call now on the different line is pre-answered 410 comprising delivering an audio message, followed by determining 412 if a predetermined response pattern has been received. If NO, the predetermined response pattern has not been received, a step of disconnecting 420 the call is performed. If YES, the predetermined response pattern has been received, a step of processing 430 the call back to the line of the telephone subscriber for ring-through is performed.

### Example 7

In this example, the audio message that is delivered by the automated system in the pre-answering step comprises a message generally in the form of: “for <<Name of Household Member #1>>, press n; for <<Name of Household Member #2>>, press m”, etc., where n and m are different whole numbers (such as whole numbers that consist of one, two or three digits).

### Example 7A

In this example, the automated system receives and maintains processing instructions that differ by household member, such as:

7A.1. Storage of a ring-sound or ring-pattern differentially based on household member.

7A.2 Storage of different “calling hours” for ringing-through calls (as opposed to putting a call into voicemail or delivering a message to call back). For example, a parent in a household gives as input into the automated system that pre-answered calls for the parent that satisfy the pre-answering step can be rung-through 24 hours, but the parent may instruct that the automated system process calls for the ten-year-old only to ring-through only during a defined time period and that outside the defined time period, the calls for the ten-year-old are told to call back.

7A.3 Storage of different forward-to-other-phone instructions differentially by household member. For example, in a case of a landline in a household with multiple adults where both have their own cell phones, when one leaves the house, he/she might opt to set calls for him to forward to his/her cell phone.

7A.4 Storage of multiple options for each household member, such as “for Alice Brown about tutoring, press 123; for Alice Brown other calls, press 100”.

### Example 8

In this example, in the case of an incoming call to a telephone subscriber, a step of disconnecting 500 the call (such as, e.g., disconnecting step 120; disconnecting step 320; disconnecting step 420; etc.) is followed by sending 502 an email to the telephone subscriber comprising at least a phone number of the disconnected call.

### Example 8A

The email in the sending 502 step also comprises a date and time when the disconnected call was disconnected.

### Example 8B

The email in the sending 502 step also comprises a content (such as a coupon; etc.) for which a third-party has paid for the automated system to deliver.

### Example 9

The automated system 200 in this Example further comprises an Enrollment Website via which input is received from a telephone subscriber enrolling for the automated system to undertake to stop robocalls from ringing through onto the telephone line of the telephone subscriber. The Enrollment Website receives a set of data comprising a telephone number of a new subscriber. Upon receipt of the telephone number of the new subscriber, the automated system 200 displays a screen to the new subscriber along the lines of “A call will be made to the telephone number you have just entered, with your instructions for what code to press to activate Robocall Stopping for that line.” The automated system 200 calls the telephone number entered by the new subscriber and delivers an instruction message such as: “We are following up your request today to be enrolled in Stop Robocall Service, To activate Stop Robocall, press 56782; if you have questions, you can call 1-800-xxx-xxxx or reach us via the website.”

While the invention has been described in terms of its preferred embodiments, those skilled in the art will recognize that the invention can be practiced with modification within the spirit and scope of the appended claims.

What we claim as our invention is:

1. A method of stopping robocalls from ringing-through, comprising:
processing incoming calls against a list of white-listed telephone numbers;
for an incoming call from a telephone number that is not white-listed, before the incoming call that is not white-listed rings to a telephone subscriber, pre-answering the call, performed by an automated system;
for an incoming call from a telephone number that is white-listed, processing, performed by the automated system, the incoming call for ring-through without pre-answering the incoming call;
for an incoming call that is not white-listed and that has been pre-answered, performing a step of delivering, performed by the automated system, an audio message; followed by,
(A) after the audio message has been delivered, determining, performed by the automated system, whether a predetermined response pattern has been received; and if no predetermined response pattern has been received, disconnecting the call;
(B) if and only if the predetermined response pattern has been received, processing the call for ring-through.

2. The method of claim 2, wherein the automated system disconnects an incoming call that is a robocall before the robocall rings through to the telephone subscriber.

3. The method of claim 1, wherein the audio message comprises a spoken name of a first individual who is the telephone subscriber or in a household of the telephone subscriber.

4. The method of claim 3, wherein the audio message that comprises the spoken name of the first individual also comprises an instruction of what to press.

5. The method of claim 4, wherein the audio message further comprises a spoken name of a second individual along with an instruction of what to press.

6. The method of claim 5, wherein the audio message further comprises a spoken name of each additional individual in the household along with an instruction of what to press for each additional individual.

7. The method of claim 1, further comprising, after the disconnecting step has been performed, a step of sending, performed by the automated system, an email to the telephone subscriber in which the email content comprises at least one disconnected number.

8. The method of claim 7, further comprising stock-piling, by the automated system, a set of disconnected numbers, and wherein the email to the telephone subscriber comprises a set of multiple disconnected numbers.

9. The method of claim 7, further comprising storing, performed by the automated system, third party content, and, prior to the email-sending, retrieving third party content and generating a coupon or message therefrom, followed by displaying the generated coupon or message into the to-be-sent email and sending the email in which is included the coupon or message and the at least one disconnected number.

10. The method of claim 1, further comprising forwarding, performed by the automated system, the incoming call that is arriving on a telephone line of the subscriber onto a different telephone line, wherein the different telephone line is outside an account of the telephone subscriber.

11. The method of claim 1, wherein the list of white-listed numbers comprises (1) a set of telephone numbers on which incoming calls that are forwarded are arriving and are being pre-answered by the automated system, and, optionally, (2) a set of telephone numbers received as input from the telephone subscriber.

12. The method of claim 10, wherein the call pre-answering step is performed on the different telephone line.

13. The method of claim 1, wherein the call pre-answering step is performed on a telephone line which is outside an account of the telephone subscriber.
